(19) United States
(12) Patent Application Publication
(10) Pub. No.: US 2026/0024495 A1
(43) Pub. Date: Jan. 22, 2026

(54) DISPLAY DEVICE AND METHOD OF DRIVING THE SAME

(71) Applicant: LG Display Co., Ltd., Seoul (KR)

(72) Inventors: Yong Hyeon ` SHIN, Paju-si (KR); Hoon Sang RYU, Paju-si (KR)

(73) Assignee: LG Display Co., Ltd., Seoul (KR)

(21) Appl. No.: 19/277,001

(22) Filed: Jul. 22, 2025

(30) Foreign Application Priority Data
Jul. 22, 2024 (KR) 10-2024-0096568

(51) Int. Cl. G09G 3/3233; G09G 3/3266

(52) U.S. Cl. CPC G09G 3/3233; G09G 3/3266; G09G 2300/0819; G09G 2300/0852; G09G 2300/0861; G09G 2310/08; G09G 2320/02; G09G 2330/021

(57) ABSTRACT

A display device includes a display panel having a subpixel for displaying an image, and a driver configured to drive the display panel. The subpixel includes a light emitting element, a driving transistor configured to generate a driving current to be supplied to the light emitting element, a first capacitor having a first electrode connected to a gate node of the driving transistor and a second electrode connected to a high-potential voltage line, and a stabilization unit configured to maintain a constant voltage between the gate node and a source node of the driving transistor when the driving transistor generates a driving current according to a voltage of the first capacitor.

### CROSS-REFERENCE TO RELATED APPLICATIONS

This application claims priority to Korean Patent Application No. 10-2024-0096568, filed in the Republic of Korea on Jul. 22, 2024, which is hereby expressly incorporated by reference as if fully set forth herein into the present application.

### BACKGROUND OF THE DISCLOSURE

### Field of the Disclosure

The present disclosure relates to a display device and a method of driving the same.

### Discussion of the Related Art

An electroluminescent display device can display an image by including a plurality of subpixels and having a light emitting element of each subpixel emit light. The light emitting element can be implemented based on an organic or inorganic material.

A subpixel of the electroluminescent display device can include a light emitting element, a driving transistor, a switching transistor, etc. In the subpixel, the switching transistor charges the subpixel with a data signal in response to a scan signal, and the driving transistor can display an image by controlling the amount of current applied to the light emitting element according to a data voltage.

Since picture quality of such an electroluminescent display device can be greatly affected by current driving capability of the subpixel, efforts are needed to improve accuracy and stability of operation of the subpixel.

### SUMMARY OF THE DISCLOSURE

Accordingly, the present disclosure is directed to a display device and a method of driving the same that substantially obviate one or more problems due to limitations and disadvantages of the related art.

The embodiments provided in the present disclosure are intended to solve or address the above-mentioned limitations and other disadvantages associated with the related art, and provide a display device capable of improving accuracy and stability of operation of a subpixel.

Additional advantages, objects, and features of the disclosure will be set forth in part in the description which follows and in part will become apparent to those having ordinary skill in the art upon examination of the following or can be learned from practice of the disclosure. The objectives and other advantages of the disclosure can be realized and attained by the structure particularly pointed out in the written description and claims hereof as well as the appended drawings.

To achieve these objects and other advantages and in accordance with the purpose of the disclosure, as embodied and broadly described herein, a display device according to aspects of the present disclosure includes a display panel including a subpixel for displaying an image, and a driver configured to drive the display panel, wherein the subpixel includes a light emitting element, a driving transistor configured to generate a driving current to be supplied to the light emitting element, a first capacitor having a first electrode connected to a gate node of the driving transistor and a second electrode connected to a high-potential voltage line, and a stabilization unit configured to maintain a constant voltage between the gate node and a source node of the driving transistor when the driving transistor generates a driving current according to a voltage of the first capacitor.

According to aspects of the present disclosure, the driver can output a scan signal for controlling driving of the subpixel in an initialization period, a data writing period, and an emission period, an on-bias stress (OBS) signal for controlling an OBS period of the subpixel, and a control signal for controlling an operation of the stabilization unit, and the stabilization unit can be initialized in the OBS period of the subpixel according to the control signal of the driver, and maintain a constant voltage between the gate node and the source node during the emission period of the subpixel.

According to aspects of the present disclosure, the stabilization unit can include a second capacitor having a first electrode connected to the gate node of the driving transistor, a first control transistor turned on by a first control signal of the driver to connect a second electrode of the second capacitor to an initialization power supply, and a second control transistor turned on by a second control signal of the driver to connect the second electrode of the second capacitor to the source node of the driving transistor.

According to aspects of the present disclosure, the first control transistor can be turned on during the OBS period, and the second control transistor can be turned on during the emission period.

According to aspects of the present disclosure, the second capacitor can be initialized by the initialization power supply during the OBS period, and is connected between the gate node and the source node of the driving transistor during the emission period.

According to aspects of the present disclosure, the second capacitor can store a difference between an initialization voltage applied to the gate node of the driving transistor and an OBS voltage applied to the source node of the driving transistor.

According to aspects of the present disclosure, the subpixel can further include a first switching transistor having a gate electrode connected to a first scan line, a first electrode connected to a drain node of the driving transistor, and a second electrode connected to the gate node of the driving transistor, a second switching transistor having a gate electrode connected to a second scan line, a first electrode connected to a data line, and a second electrode connected to the source node of the driving transistor, a third switching transistor having a gate electrode connected to a light emitting signal line, a first electrode connected to the high-potential voltage line, and a second electrode connected to the source node of the driving transistor, a fourth switching transistor having a gate electrode connected to the light emitting signal line, a first electrode connected to the drain node of the driving transistor, and a second electrode connected to an anode of the light emitting element, a fifth switching transistor having a gate electrode connected to a fourth scan signal line, a first electrode connected to a first initialization voltage line, and a second electrode connected to the first capacitor, a sixth switching transistor having a gate electrode connected to an OBS signal line, a first electrode connected to an input line of a VAR voltage line, and a second electrode connected to the anode of the light emitting element, and a seventh switching transistor having a gate electrode connected to the OBS signal line, a first electrode connected to the OBS voltage line, and a second electrode connected to the source node of the driving transistor.

According to aspects of the present disclosure, the stabilization unit can include a second capacitor having a first electrode connected to the gate node of the driving transistor, an eighth switching transistor having a gate electrode connected to a fifth scan signal line, a first electrode connected to a second electrode of the second capacitor, and a second electrode connected to an initialization power supply, and a ninth switching transistor having a gate electrode connected to a sixth scan signal line, a first electrode connected to the second electrode of the second capacitor, and a second electrode connected to the source node of the driving transistor.

According to aspects of the present disclosure, the second capacitor can be initialized by the initialization power supply and connected between the gate node and the source node of the driving transistor during the emission period.

In another aspect of the present disclosure, a method of driving a display device, which includes a light emitting element, a driving transistor configured to generate a driving current to be supplied to the light emitting element, and a first capacitor having a first electrode connected to a gate node of the driving transistor and a second electrode connected to a high-potential voltage line, includes applying an initialization voltage to the gate node of the driving transistor, applying an OBS voltage to a source node of the driving transistor, and initializing a second capacitor connected to the gate node of the driving transistor by the initialization voltage, applying the initialization voltage to the gate node of the driving transistor and a drain node of the driving transistor, storing a data voltage in the first capacitor, applying an OBS voltage to the source node of the driving transistor, and causing the light emitting element to emit light based on a driving current generated from the driving transistor according to the data voltage stored in the first capacitor in a state in which the second capacitor is connected between the gate node and the source node of the driving transistor.

According to aspects of the present disclosure, the second capacitor can store a difference between the initialization voltage applied to the gate node of the driving transistor and the OBS voltage applied to the source node of the driving transistor.

It is to be understood that both the foregoing general description and the following detailed description of the present disclosure are examples and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram schematically illustrating a display device according to one or more embodiments of the present disclosure;

FIGS. 2 and 3 are diagrams for describing an example of a configuration of a gate-in-panel (GIP) type gate driver according to one or more embodiments of the present disclosure;

FIG. 4 is a circuit diagram of a subpixel according to an embodiment of the present disclosure;

FIG. 5 is a diagram illustrating a driving waveform of the subpixel and voltage change at each node according to an embodiment of the present disclosure;

FIGS. 6 to 10 are diagrams illustrating a method of driving the subpixel according to the driving waveform of FIG. 5; and

FIGS. 11A to 13B are graphs illustrating examples of simulation results of the display device according to the embodiments of the present disclosure and a display device according to a comparative example.

### DETAILED DESCRIPTION OF THE EMBODIMENTS

Advantages and features of the present disclosure and a method of achieving the advantages and features will become clear with reference to the embodiments described in detail below together with the accompanying drawings. However, the present disclosure is not limited to the embodiments disclosed below and can be implemented in various different forms, and the present embodiments are provided only to make the disclosure of the present disclosure complete and to fully inform a person having ordinary skill in the art to which the present disclosure pertain of the scope of the invention.

The shapes, sizes, ratios, angles, numbers, etc. disclosed in the drawings to describe the embodiments of the present disclosure are illustrative, and thus the present disclosure is not limited to the illustrated matters. The same reference numerals refer to the same components throughout the specification. When the terms “include”, “have”, and “consist of”, etc. are used in the present disclosure, other parts can be added unless “only” is used. When a component is expressed in a singular form, this includes the case where the component is plural unless there is a specifically explicit description.

When interpreting a component, the component is interpreted as including an error range even if there is no separate explicit description.

When describing a positional relationship, for example, when a positional relationship between two parts is described as “on”, “above”, “below”, “next to”, etc., one or more other parts can be located between the two parts, unless “immediately” or “directly” is used.

Even though the terms first, second, etc. can be used to describe various components, these components are not limited by these terms. These terms are only used to distinguish one component from another. Thus, a first component mentioned below can be a second component within the technical concept of the present disclosure. Further, the term “can” fully encompasses all the meanings and coverages of the term “may” and vice versa.

In addition, a pixel circuit of a display device described below can include a plurality of transistors. The transistors can be implemented as an oxide thin film transistor (TFT) including an oxide semiconductor, an LTPS TFT including low temperature poly silicon (LTPS), etc. Each of the transistors can be implemented as a p-channel TFT or an n-channel TFT.

A transistor is a three-electrode device that includes a gate, a source, and a drain. The source is an electrode that supplies carriers to the transistor. Inside the transistor, carriers start to flow from the source. The drain is an electrode through which carriers exit the transistor. In the transistor, carriers flow from the source to the drain. In the case of an n-channel transistor, since the carriers are electrons, a source voltage is lower than a drain voltage so that electrons can flow from the source to the drain. In the n-channel transistor, current flows in a direction from the drain to the source. In the case of a p-channel transistor (PMOS), since the carriers are holes, the source voltage is higher than the drain voltage so that the holes can flow from the source to the drain. In the p-channel transistor, since holes flow from the source to the drain, current flows from the source to the drain. It should be noted that the source and the drain of the transistor are not fixed. For example, the source and the drain can be changed depending on the applied voltage. Therefore, the disclosure is not limited by the source and the drain of the transistor. In the following description, the source and the drain of the transistor will be referred to as first and second electrodes.

A gate signal swings between a gate-on-voltage and a gate-off-voltage. The gate-on-voltage is set to a voltage higher than a threshold voltage of the transistor, and the gate-off-voltage is set to a voltage lower than the threshold voltage of the transistor. The transistor turns on in response to the gate-on-voltage, and turns off in response to the gate-off-voltage. In the n-channel transistor, the gate-on-voltage can be a gate-high-voltage (VGH), and the gate-off-voltage can be a gate-low-voltage (VGL). In the p-channel transistor, the gate-on-voltage can be a VGL, and the gate-off-voltage can be a VGH.

Each pixel of an electroluminescent display device includes a light emitting element and a driving element that generates pixel current according to a voltage between a gate and a source to drive the light emitting element. The light emitting element includes an anode, a cathode, and an organic compound layer formed between these electrodes. The organic compound layer can include, but is not limited to, a hole injection layer (HIL), a hole transport layer (HTL), an emission layer (EML), an electron transport layer (ETL), an electron injection layer (EIL), etc. When a pixel current flows in the light emitting element, holes passing through the HTL and electrons passing through the ETL move to the EML, thereby forming excitons, and as a result, the EML can emit visible light.

Recently, there have been increasing attempts to implement some transistors included in the pixel circuit of the electroluminescent display device as oxide transistors. Oxide transistors use an oxide referred to as IGZO, which is a combination of In (indium), Ga (gallium), Zn (zinc), and O (oxygen), instead of polysilicon as a semiconductor material.

An oxide transistor has low off-current, and thus has an advantage of high driving stability and reliability during low-speed operation in which an off period of the transistor is relatively long. Therefore, the oxide transistor can be adopted by a large liquid crystal display device that requires high resolution and low power operation, or an OLED TV whose screen size is not suitable for a low-temperature polysilicon process.

The display device according to the present embodiment can be implemented as a television, a video player, a personal computer (PC), a home theater, an automobile electrical device, a smartphone, etc., but the present disclosure is not limited thereto. The display device according to an embodiment of the present disclosure can be implemented as a light emitting display device (LED), a quantum dot display device (QDD), a liquid crystal display device (LCD), etc. However, for convenience of description, a display device that directly emits light based on an inorganic light emitting diode or an organic light emitting diode is taken as an example below.

Throughout the specification, the same reference numerals refer to substantially the same components. Hereinafter, embodiments of the present disclosure will be described in detail with reference to the attached drawings. All the components of each display device according to all embodiments of the present disclosure are operatively coupled and configured. In the following description, when it is determined that a detailed description of a known function or configuration related to the present disclosure can unnecessarily obscure the gist of the present disclosure, the detailed description will be omitted.

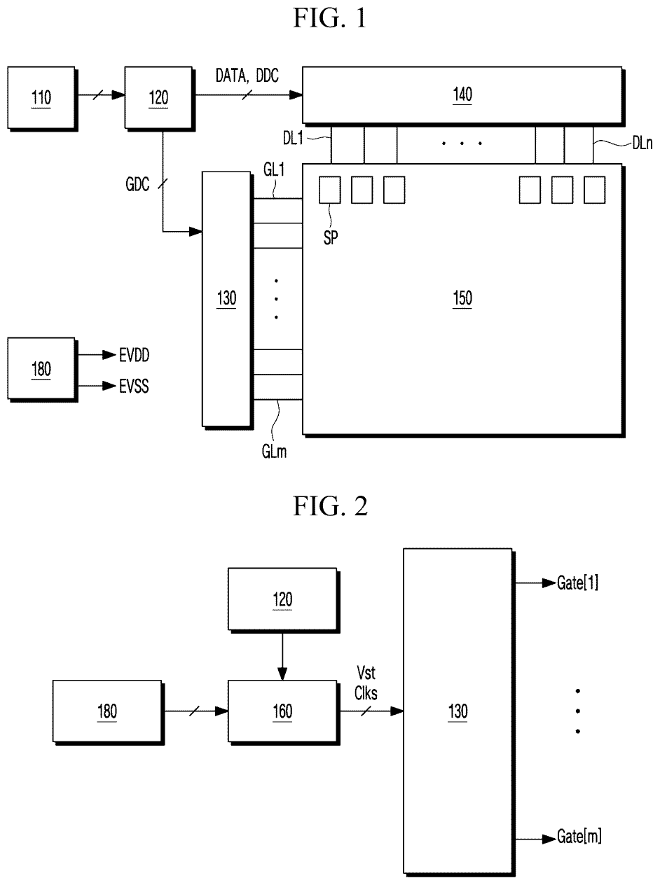

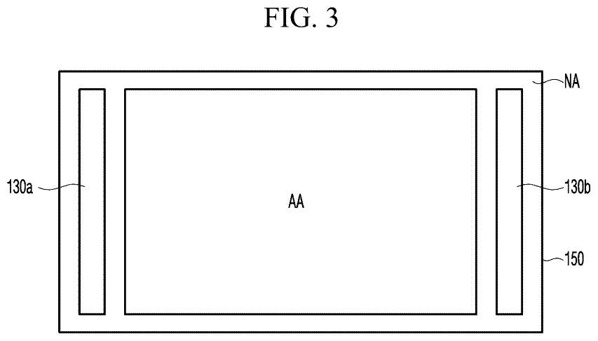

FIG. 1 is a block diagram schematically illustrating a display device according to aspects of the present disclosure, and FIGS. 2 and 3 are diagrams for describing a configuration of a GIP type gate driver according to aspects of the present disclosure.

Referring to FIGS. 1 to 3, the display device can include a timing controller 120, a gate driver 130, a data driver 140, a display panel 150, a power supply 180, etc.

An image supply unit (set or host system) 110 can output various driving signals in addition to an image data signal supplied from the outside or an image data signal stored in an internal memory. The image supply unit 110 can supply data signals and various driving signals to the timing controller 120.

The timing controller 120 can output a gate timing control signal GDC for controlling the operation timing of the gate driver 130, a data timing control signal DDC for controlling the operation timing of the data driver 140, various synchronization signals (Vsync, which is a vertical synchronization signal, and Hsync, which is a horizontal synchronization signal), etc. The timing controller 120 can supply a data signal DATA supplied from the image supply unit 110 together with the data timing control signal DDC to the data driver 140. The timing controller 120 can be formed as an IC (Integrated Circuit) and mounted on a printed circuit board, but the present disclosure is not limited thereto.

The gate driver 130 can output a gate signal (or gate voltage) in response to the gate timing control signal GDC supplied from the timing controller 120. The gate driver 130 can supply the gate signal to subpixels included in the display panel 150 through gate lines GL1 to GLm. Here, m can be a real number such as a positive integer. The gate driver 130 can be formed as an IC or directly formed on the display panel 150 in a GIP manner, but the present disclosure is not limited thereto. However, for convenience of description, the GIP type gate driver will be described below as an example, as shown in FIG. 2 and FIG. 3.

The GIP type gate driver 130 can include shift registers 130a and 130b formed using a GIP method on one side and the other side of a non-active area NA of the display panel 150. The shift registers 130a and 130b can be formed as thin films on the non-active area NA of the display panel 150 using the GIP method. The GIP type gate driver 130 can output gate signals Gate [1] to Gate [m] that can turn on or off transistors formed in an active area AA (or display area) of the display panel 150. A non-active area or non-display area can be disposed outside of the active area AA.

The GIP type gate driver 130 can operate based on signals and voltages output from the timing controller 120, the power supply 180, and a level shifter 160. The level shifter 160 can generate gate control signals required for driving the GIP type gate drivers 130, 130a, and 130b based on signals and voltages output from the timing controller 120 and the power supply 180.

The data driver 140 can sample and latch the data signal DATA in response to the data timing control signal DDC supplied from the timing controller 120, convert a digital data signal into an analog data voltage based on a gamma reference voltage, and output the analog data voltage. The data driver 140 can supply a data voltage to subpixels included in the display panel 150 through data lines DL1 to DLn. Here, n can be a real number such as a positive integer. The data driver 140 can be formed as an IC and mounted on the display panel 150 or on a printed circuit board, but the present disclosure is not limited thereto.

The power supply 180 can generate a high-potential voltage and a low-potential voltage based on an external input voltage supplied from the outside, and output the generated voltages through a high-potential voltage line EVDD and a low-potential voltage line EVSS. The power supply 180 can generate and output not only the high-potential voltage and the low-potential voltage, but also a voltage required to drive the gate driver 130 or a voltage required to drive the data driver 140.

The display panel 150 can be manufactured based on a rigid or flexible substrate made of glass, silicon, polyimide, etc. The display panel 150 can include a plurality of subpixels SP for displaying an image. The subpixels SP can directly emit light toward an upper substrate, a lower substrate, or the upper substrate and the lower substrate of the display panel 150. The subpixels SP can emit one of colors such as red, green, blue, and white. The display panel 150 can display an image based on pixels including red subpixels, green subpixels, and blue subpixels, or pixels including red subpixels, green subpixels, blue subpixels, and white subpixels.

Meanwhile, in the above description, the timing controller 120, the gate driver 130, the data driver 140, etc. are described as individual components. However, depending on the implementation method of the display device, one or more of the timing controller 120, the gate driver 130, and the data driver 140 can be integrated into one IC.

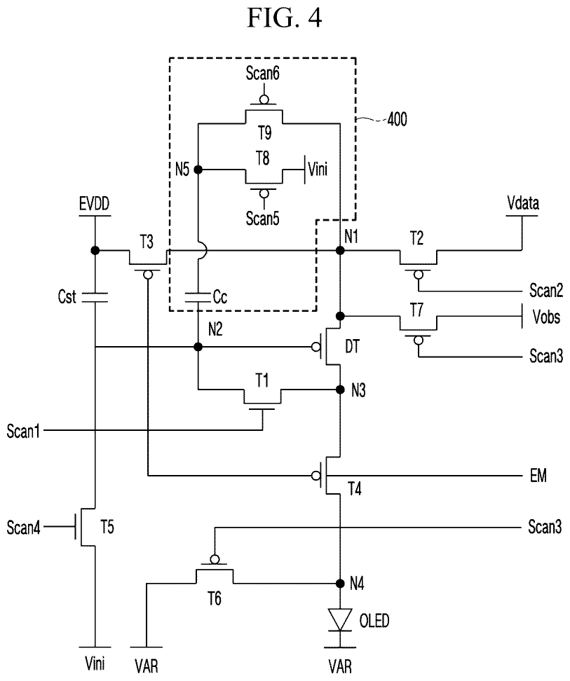

FIG. 4 is a circuit diagram of a subpixel according to an embodiment of the present disclosure.

In the description below, a first electrode of a transistor can be either a source electrode or a drain electrode, and a second electrode of the transistor can be the other of the source electrode and the drain electrode.

Referring to FIG. 4, one subpixel can be supplied with a high-potential voltage EVDD, a low-potential voltage EVSS, an initialization voltage Vini, an anode reset voltage VAR, and an on-bias stress (OBS) voltage Vobs, and can receive input of first to sixth scan signals Scan1 to Scan6, an emission signal EM, and a data voltage signal Vdata.

One subpixel can include an OLED (organic light emitting diode), a driving TFT DT, a first capacitor Cst, a second capacitor Cc, and first to ninth switching TFTs T1 to T9. Each TFT of the subpixel can be configured as a p-type MOSFET PMOS or an n-type MOSFET NMOS. In the present embodiment, a description will be given using an example in which the first switching TFT T1 and the fifth switching TFT T5 are implemented as n-type, and the driving TFT DT and the remaining switching TFTs T2 to T4, and T6 to T9 are implemented as p-type. Accordingly, the first switching TFT T1 and the fifth switching TFT T5 are turned on when a high voltage is applied, and the remaining switching TFTs T2 to T4, and T6 to T7 are turned on when a low voltage is applied.

According to the embodiment of the present disclosure, in a subpixel circuit, the first transistor T1 can function as a compensation transistor, the second transistor T2 can function as a data supply transistor, the third and fourth transistors T3 and T4 can function as light emission control transistors, the fifth and sixth transistors T5 and T6 can function as initialization transistors, and the seventh transistor T7 can function as a bias transistor.

In addition, the subpixel circuit according to the embodiment of the present disclosure can include a stabilization circuit 400 that stabilizes a gate-source voltage Vgs of the driving TFT DT. The stabilization circuit 400 can include the second capacitor Cc connected between a gate node and a source node N2 and N1 of the driving TFT DT, an eighth switching TFT T8, and a ninth switching TFT T9.

The OLED emits light by a driving current supplied from the driving TFT DT. An anode of the OLED can be connected to a fourth node N4, and a cathode of the OLED can be connected to a wire to which the low-potential voltage EVSS is provided.

The driving TFT DT can have a gate electrode connected to the second node N2, a first electrode connected to the first node N1, and a second electrode connected to a third node N3. The driving TFT DT can control a driving current supplied to the OLED based on a voltage of the second node N2.

The first capacitor Cst has one electrode connected to the second node N2 to which the gate electrode of the driving TFT DT is connected, and the other electrode connected to the high-potential voltage line EVDD. The first capacitor Cst can store a data voltage for a predetermined period of time and provide the data voltage to the OLED.

The first switching TFT T1 can be turned on in response to a first scan signal Scan1. When the first switching TFT T1 is turned on, the gate electrode and a drain electrode, which is the second electrode, of the driving TFT DT are connected to diode-connect the driving TFT DT. The first switching TFT T1 can include a gate electrode connected to an input line of the first scan signal Scan1, a first electrode connected to the second node N2, and a second electrode connected to the third node N3. The first switching TFT T1 can be an n-type MOSFET NMOS and can be implemented as an oxide TFT to have a low off-current and minimize leakage current during a turn-off period. Accordingly, the first switching TFT T1 is turned on in response to the first scan signal Scan1 at a high level, which is a turn-on voltage, and can sample a threshold voltage Vth of the driving TFT DT by diode-connecting the second node N2 and the third node N3. This first switching TFT T1 can be a compensation transistor.

The second switching TFT T2 can be turned on in response to the second scan signal Scan2. When the second switching TFT T2 is turned on, the data voltage signal Vdata is applied to the first node N1, which is the first electrode of the driving TFT DT. The second switching TFT T2 can include a gate electrode connected to an input line of the second scan signal Scan2, a first electrode connected to a data line to which the data voltage signal Vdata is supplied, and a second electrode connected to the first node N1. The second switching TFT T2 can apply the data voltage signal Vdata supplied from the data line to the first node N1, which is the first electrode of the driving TFT DT, in response to the second scan signal Scan2 at a low level, which is a turn-on voltage. The second switching TFT T2 can be a data supply transistor.

A control operation is performed to simultaneously turn on/off the third switching TFT T3 and the fourth switching TFT T4 according to the emission signal EM simultaneously input to respective gate electrodes thereof. The third switching TFT T3 and the fourth switching TFT T4 can control whether the OLED emits light. The third switching TFT T3 can have a first electrode connected to the high-potential voltage line EVDD and a second electrode connected to the first node N1. The third switching TFT T3 can serve to transmit the high-potential voltage EVDD to the first electrode of the driving TFT DT in response to the emission signal EM. The fourth switching TFT T4 can have a first electrode connected to the third node N3 and a second electrode connected to the fourth node N4. The fourth switching TFT T4 can serve to transmit a driving current to the anode of the OLED in response to the emission signal EM.

The fifth switching TFT T5 can be turned on in response to the fourth scan signal Scan4. The fifth switching TFT T5 is turned on to apply the initialization voltage Vini to the second node N2, which is the gate electrode of the driving TFT DT. The fifth switching TFT T5 can include a gate electrode connected to an input line of the fourth scan signal Scan4, a first electrode connected to the input line of the initialization voltage Vini, and a second electrode connected to the second node N2. The fifth switching TFT T5 can initialize the gate electrode of the driving TFT DT by applying the initialization voltage Vini to the second node N2, which is the gate electrode of the driving TFT DT, in response to the fourth scan signal Scan4 at a high level, which is a turn-on voltage.

The sixth switching TFT T6 can be turned on in response to the third scan signal Scan3. The sixth switching TFT T6 is turned on to apply the anode reset voltage VAR to the anode of the OLED. The sixth switching TFT T6 can include a gate electrode connected to an input line of the third scan signal Scan3, a first electrode connected to the input line of the anode reset voltage VAR, and a second electrode connected to the fourth node N4. The sixth switching TFT T6 can apply the anode reset voltage VAR to the anode of the OLED in response to the third scan signal Scan3 at a low level, which is a turn-on voltage. The OLED can have a parasitic capacitor formed between the anode and the cathode. Further, while the OLED emits light, the parasitic capacitor is charged so that the anode can have a specific voltage. Therefore, by applying the anode reset voltage VAR to the anode through the sixth switching TFT T6, the OLED can initialize the quantity of electric charge accumulated in the OLED.

The seventh switching TFT T7 can be turned on in response to the third scan signal Scan3. The seventh switching TFT T7 is turned on to apply the OBS voltage Vobs to the first electrode of the driving TFT DT. The seventh switching TFT T7 can include a gate electrode connected to the input line of the third scan signal Scan3, a first electrode connected to the input line of the OBS voltage Vobs, and a second electrode connected to a first node N1. The seventh switching TFT T7 can apply the OBS voltage Vobs to the first electrode of the driving TFT DT in response to the third scan signal Scan3 at a low level, which is a turn-on voltage.

In the present disclosure, the gate electrodes of the sixth and seventh switching TFTs T6 and T7 are configured to receive the third scan signal Scan3 in common. However, the present disclosure is not necessarily limited thereto, and the gate electrodes of the sixth and seventh switching TFTs T6 and T7 can be configured to receive separate scan signals and be controlled independently, respectively.

The stabilization circuit 400 is controlled by the fifth scan signal Scan5 and the sixth scan signal Scan6, and is connected between the gate node and the source node N2 and N1 of the driving TFT DT, thereby being able to minimize fluctuation in the gate-source voltage Vgs of the driving TFT DT. The stabilization circuit 400 can include the second capacitor Cc, the eighth switching TFT T8, and the ninth switching TFT T9.

The second capacitor Cc has one electrode connected to the second node N2 to which the gate electrode of the driving TFT DT is connected, and the other electrode connected to a fifth node N5 connected to the eighth switching TFT T8 or the ninth switching TFT T9. The second capacitor Cc is connected between the gate node and the source node N2 and N1 of the driving TFT DT, and can be initialized in a first OBS period of each frame. In this instance, the gate node N2 is set to Vini and the source node N1 is set to the voltage Vobs, so that the same gate-source voltage Vgs can be set in the driving TFT DT regardless of a data voltage of a previous frame.

The eighth switching TFT T8 can be turned on in response to the fifth scan signal Scan5. The eighth switching TFT T9 can be turned on to apply the initialization voltage Vini to the other electrode of the second capacitor Cc. The eighth switching TFT T8 can include a gate electrode connected to the input line of the fifth scan signal Scan5, a first electrode connected to the second capacitor Cc, and a second electrode connected to the input line of the initialization voltage Vini. The eighth switching TFT T8 can initialize the voltage of the second capacitor Cc by the initialization voltage Vini in response to the fifth scan signal Scan5 at a low level, which is a turn-on voltage.

The ninth switching TFT T9 can be turned on in response to the sixth scan signal Scan6. The ninth switching TFT T9 is turned on to connect the other electrode of the second capacitor Cc to the first node N1 to which the source electrode of the driving TFT DT is connected. The ninth switching TFT T9 can include a gate electrode connected to the input line of the sixth scan signal Scan6, a first electrode connected to the second capacitor Cc, and a second electrode connected to the first node N1. The ninth switching TFT T9 can connect the second capacitor Cc between the source electrode and the gate electrode of the driving TFT DT in response to the sixth scan signal Scan6 at a low level, which is a turn-on voltage.

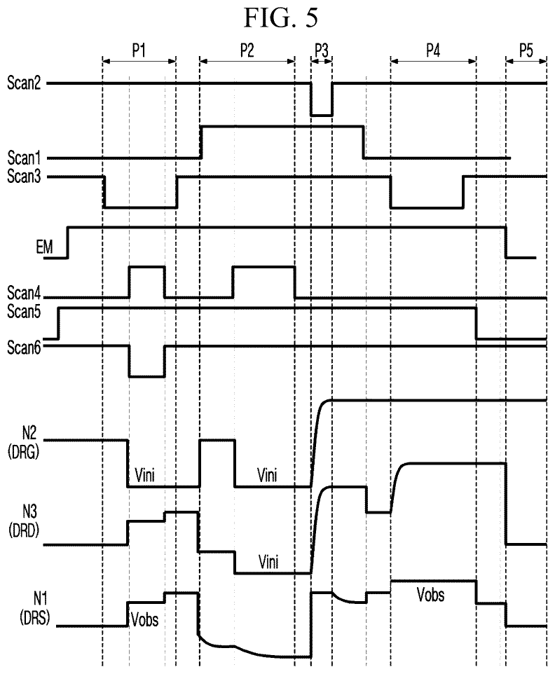

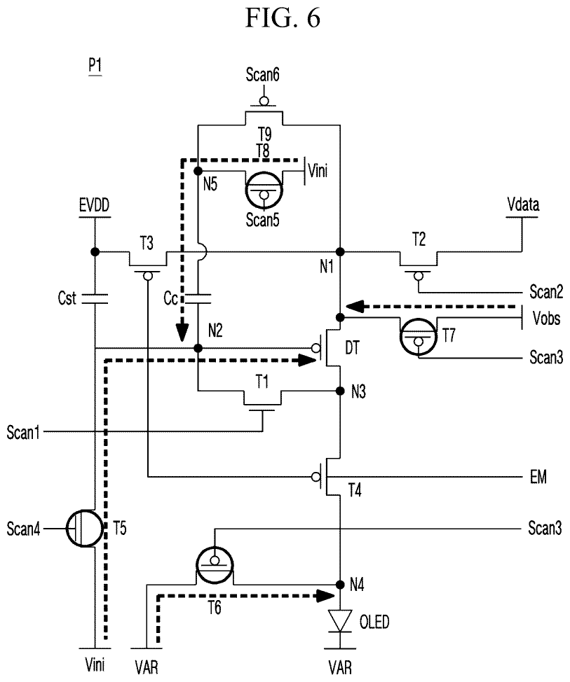

FIG. 5 is a diagram illustrating a driving waveform of the subpixel and voltage change at each node according to an embodiment of the present disclosure, and FIGS. 6 to 10 are diagrams illustrating a method of driving the subpixel according to the driving waveform of FIG. 5.

Referring to FIG. 5, a driving period of the subpixel can include first to fifth periods P1 to P5. The first to fifth periods P1 to P5 can include one or more OBS driving periods, an initial period, a data writing period, and an emission period. In the following description, the case where the first period P1 is a first OBS period, the second period P2 is an initial period, the third period P3 is a data writing period, the fourth period P4 is a second OBS period, and the fifth period P5 is an emission period will be given as an example.

FIG. 6 is an equivalent circuit diagram illustrating an operating state of the subpixel in the first OBS period P1. In the first OBS period P1, the voltages of the gate node and the source node of the driving TFT DT can be initialized, and the voltage of the second capacitor Cc connected between the gate node and the source node of the driving TFT DT can be initialized. In addition, by applying a high-level gate-source voltage Vgs, the hysteresis phenomenon of the driving TFT DT can be alleviated. In addition, the anode voltage of the OLED can be initialized.

Referring to FIGS. 5 and 6, in the first OBS period P1, the third scan signal Scan3, the fourth scan signal Scan4, and the fifth scan signal Scan5 are applied at the on level, and the first, second, and sixth scan signals Scan1, Scan2, Scan6 and the emission signal EM are applied at the off level. Accordingly, among the switching TFTs included in the subpixel, the fifth switching TFT T5, the sixth switching TFT T6, the seventh switching TFT T7, and the eighth switching TFT T8 are turned on.

The sixth switching TFT T6 is turned on in response to the third scan signal Scan3 applied at the on level. When the sixth switching TFT T6 is turned on, the anode reset voltage VAR can be applied to the fourth node N4 to which the anode of the OLED is connected. Accordingly, the anode of the OLED can be initialized to the VAR voltage.

The seventh switching TFT T7 is turned on in response to the third scan signal Scan3 applied at the on level. When the seventh switching TFT T7 is turned on, a bias voltage Vobs can be applied to the first node N1 to which the source node of the driving TFT DT is connected. The bias voltage Vobs is a voltage at least greater than a data voltage Vdata, and by applying the voltage Vobs, which is a high-potential voltage, to the source node, the hysteresis phenomenon of the driving TFT DT can be alleviated.

The fifth switching TFT T5 is turned on in response to the fourth scan signal Scan4 applied at the on level. When the fifth switching TFT T5 is turned on, the initialization voltage Vini can be applied to the second node N2 to which the gate electrode of the driving TFT DT is connected. Accordingly, the gate node of the driving TFT DT can be initialized to the Vini voltage. As a result, the gate-source voltage Vgs of the driving TFT DT is initialized to Vini-Vobs.

The eighth switching TFT T8 is turned on in response to the fifth scan signal Scan5 applied at the on level. When the 8th switching TFT T8 is turned on, the initialization voltage Vini can be applied to the second capacitor Cc connected to the gate node N2 of the driving TFT DT. Here, since the initialization voltage Vini is also applied to the gate node N2, the voltage of the second capacitor Cc can be initialized.

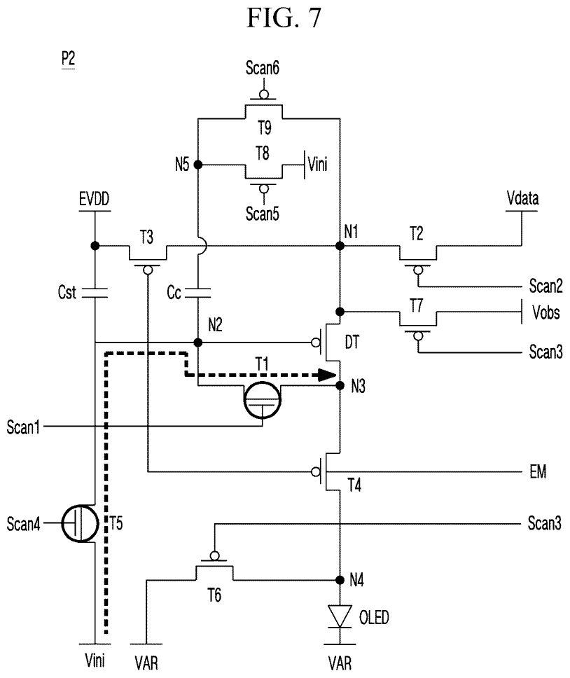

FIG. 7 is an equivalent circuit diagram illustrating an operating state of the subpixel in the initial period P2. The voltages of the gate node and the source node of the driving TFT DT can be initialized in the initial period P2.

Referring to FIGS. 5 and 7, in the initial period P2, the first scan signal Scan1 and the fourth scan signal Scan4 are applied at the on level, and the second, third, fifth, and sixth scan signals Scan2, Scan3, Scan5, and Scan6 and the emission signal EM are applied at the off level. Accordingly, among the switching TFTs included in the subpixel, the first switching TFT T1 and the fifth switching TFT T5 are turned on.

The first switching TFT T1 is turned on in response to the first scan signal Scan1 applied at the on level. When the first switching TFT T1 is turned on, the gate node N2 and the drain node N3 of the driving TFT DT are interconnected, so that the driving TFT DT is in a diode-connected state.

The fifth switching TFT T5 is turned on in response to the fourth scan signal Scan4 applied at the on level. When the fifth switching TFT T5 is turned on, the initialization voltage Vini can be applied to the second node N2 to which the gate electrode of the driving TFT DT is connected. Accordingly, the gate node of the driving TFT DT can be initialized to the Vini voltage. Here, since the first switching TFT T1 is turned on, and the gate node N2 and the drain node N3 of the driving TFT DT are interconnected, the drain node N3 of the driving TFT DT can also be initialized to the Vini voltage.

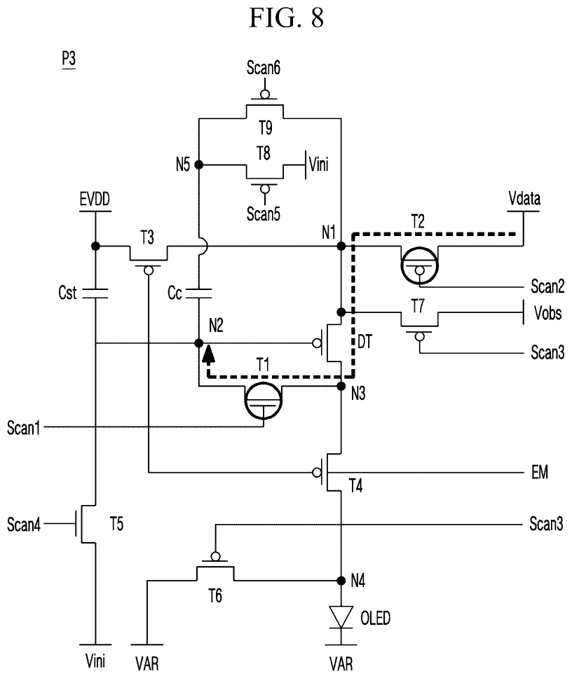

FIG. 8 is an equivalent circuit diagram illustrating an operating state of the subpixel during the data writing period P3. During the data writing period P3, the data voltage Vdata can be applied to the source node of the driving TFT DT to write the data voltage.

Referring to FIGS. 5 and 8, during the data writing period P3, the first scan signal Scan1 and the second scan signal Scan2 are applied at the on level, and the third, fourth, fifth, and sixth scan signals Scan3, Scan4, Scan5, and Scan6 and the emission signal EM are applied at the off level. Accordingly, among the switching TFTs included in the subpixel, the first switching TFT T1 and the second switching TFT T2 are turned on.

The first switching TFT T1 is turned on in response to the first scan signal Scan1 applied at the on level. When the first switching TFT T1 is turned on, the gate node N2 and the drain node N3 of the driving TFT DT are interconnected, so that the driving TFT DT is in a diode-connected state.

The second switching TFT T2 is turned on in response to the second scan signal Scan2 applied at the on level. When the second switching TFT T2 is turned on, the data voltage Vdata can be applied to the first node N1 to which the source electrode of the driving TFT DT is connected. Since the driving TFT DT is in a diode-connected state, the data voltage Vdata applied to the source electrode of the driving TFT DT can be reflected in the gate node N2 of the driving TFT DT and written as a data voltage.

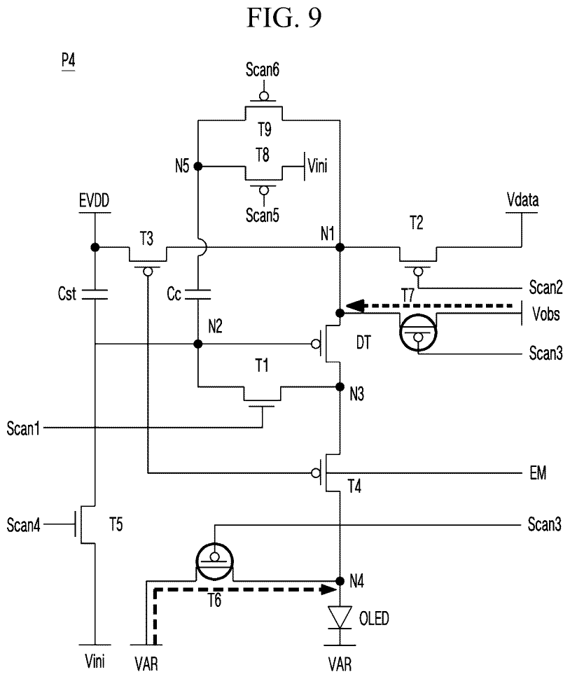

FIG. 9 is an equivalent circuit diagram illustrating an operating state of the subpixel in the second OBS period P4. In the second OBS period P4, the voltages of the gate node and the source node of the driving TFT DT can be initialized, and the anode voltage of the OLED can be initialized.

Referring to FIGS. 5 and 9, in the second OBS period P4, the third scan signal Scan3 is applied at the on level, and the remaining scan signals Scan1, Scan2, Scan4, Scan5, and Scan6 and the emission signal EM are applied at the off level. Accordingly, among the switching TFTs included in the subpixel, the sixth switching TFT T6 and the seventh switching TFT T7 are turned on.

The sixth switching TFT T6 is turned on in response to the third scan signal Scan3 applied at the on level. When the sixth switching TFT T6 is turned on, the initialization voltage VAR can be applied to the fourth node N4 to which the anode of the OLED is connected. Accordingly, the anode of the OLED can be initialized to the VAR voltage.

The seventh switching TFT T7 is turned on in response to the third scan signal Scan3 applied at the on level. When the seventh switching TFT T7 is turned on, the bias voltage Vobs can be applied to the first node N1 to which the source node of the driving TFT DT is connected.

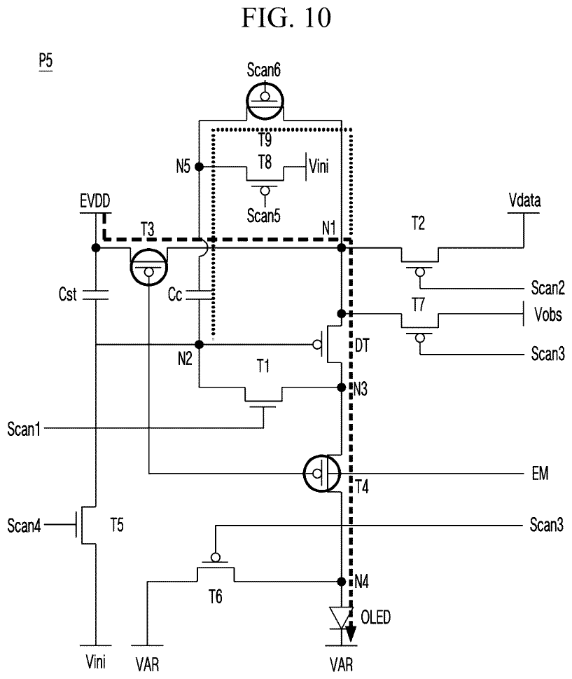

FIG. 10 is an equivalent circuit diagram illustrating an operating state of the subpixel during the emission period P5. During the emission period P5, the driving TFT DT supplies driving power to the OLED according to the data voltage written during the data writing period P3, so that the OLED can light up. Here, when the driving TFT DT supplies driving power to the OLED, the gate node and source node of the driving TFT DT are connected through the second capacitor Cc, so that the gate-source voltage Vgs of the driving TFT DT can be stabilized.

Referring to FIGS. 5 and 10, during the emission period P5, the emission signal EM and the sixth scan signal Scan6 are applied at the on level, and the remaining scan signals Scan1, Scan2, Scan3, and Scan4, and Scan5 are applied at the off level. Accordingly, among the switching TFTs included in the subpixel, the third switching TFT T3, the fourth switching TFT T4, and the ninth switching TFT T9 are turned on.

In response to the emission signal EM applied at the on level, the third switching TFT T3 and the fourth switching TFT T4 are turned on. In response to the third switching TFT T3 being turned on, the high-potential voltage EVDD is applied to the first node N1, and in response to the fourth switching TFT T4 being turned on, a current path between the third node N3 and the fourth node N4 is formed. Accordingly, depending on the voltage of the second node N2 connected to the gate electrode of the driving TFT DT, a driving current can be applied to the OLED through the driving TFT DT to emit light.

In response to the sixth scan signal Scan6 applied at the on level, the ninth switching TFT T9 is turned on. In response to the ninth switching TFT T9 being turned on, the source node N1 and the gate node N2 of the driving TFT DT can be connected to the second capacitor Cc to maintain the gate-source voltage Vgs constant.

Accordingly, the gate-source voltage Vgs of the driving TFT DT is maintained constant by the second capacitor Cc, so that the OLED can emit light with accurate luminance according to the data voltage Vdata without being affected by a voltage of a previous frame. In addition, even when the EVDD fluctuates or the voltage of the source node N1 fluctuates, the voltage of the gate node N2 is compensated by the second capacitor Cc, so that the gate-source voltage Vgs can be maintained constant.

As described above, the subpixel according to the embodiment of the present disclosure can include the stabilization circuit 400 that stabilizes the gate-source voltage Vgs of the driving TFT DT. The stabilization circuit 400 can include the second capacitor Cc connected to the gate node N2 of the driving TFT DT, and the eighth switching TFT T8 and the ninth switching TFT T9 that connect the second capacitor Cc to the input line of the initialization voltage or to the source node N1. The second capacitor Cc of the stabilization circuit 400 is initialized during the first OBS period in which the gate node N2 and the source node N1 of the driving TFT DT are each initialized to Vini-Vobs, and can constantly maintain the gate-source voltage Vgs of the driving TFT DT at a difference of Vini-Vobs by being connected between the gate node N2 and the source node N1 during the emission period.

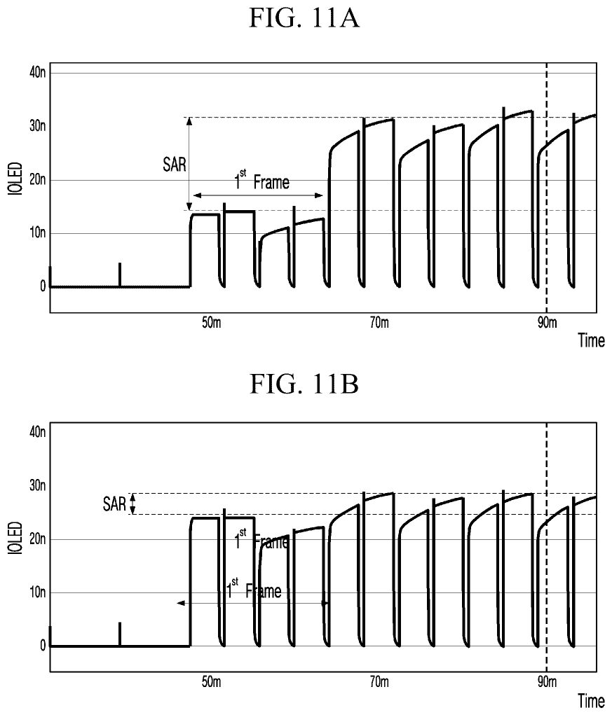

FIGS. 11A to 13B are graphs illustrating simulation results of driving characteristics of a subpixel of a comparative example to which the stabilization circuit 400 is not applied and a subpixel according to the embodiments of the present disclosure to which the stabilization circuit 400 is applied.

More specifically, FIGS. 11A and 11B are graphs illustrating simulation results of a current amount IOLED of the OLED when an image pattern changes from black to white, where FIG. 11A is a simulation result of the subpixel of the comparative example and FIG. 11B is a simulation result of the subpixel of the embodiments.

At the time of driving the display device, when the image pattern changes from black to white, the hysteresis of the driving transistor can cause an SAR (Shooting Amount Ratio) defect in which luminance of a first frame severely changes when compared to the case where the image pattern changes from white to white.

In the case of the embodiments of the present disclosure, the gate-source voltage Vgs of the driving TFT DT can be kept constant as the difference Vini-Vobs by the second capacitor Cc connected between the gate node N2 and the source node N1 of the driving TFT DT, so that current can be supplied to the OLED according to the data voltage under the same gate-source voltage Vgs condition without being affected by the hysteresis of the driving transistor.

Accordingly, it is possible to confirm that the SAR defect is significantly smaller in the simulation result of the subpixel of the embodiments of FIG. 11B than in the simulation result of the subpixel of the comparative example of FIG. 11A.

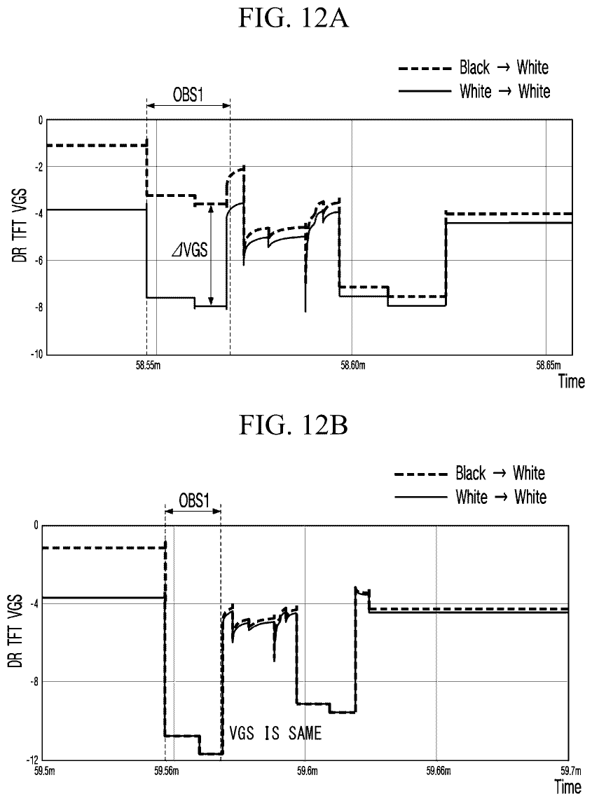

FIGS. 12A and 12B are graphs illustrating simulation results of the gate-source voltage Vgs of the driving TFT DT in each driving period of the subpixel when the image pattern changes from black to white, where FIG. 12A is a simulation result of the subpixel of the comparative example and FIG. 12B is a simulation result of the subpixel of the embodiments.

According to the simulation result of the subpixel of the comparative example of FIG. 12A, it can be seen that a difference B in the gate-source voltage Vgs of the driving TFT DT increases when the image pattern changes from white to white and changes from black to white.

On the other hand, according to the simulation result of the subpixel of the embodiments of FIG. 12B, it is possible to confirm that the gate-source voltage Vgs of the driving TFT DT is maintained constant after the first OBS period OBS1.

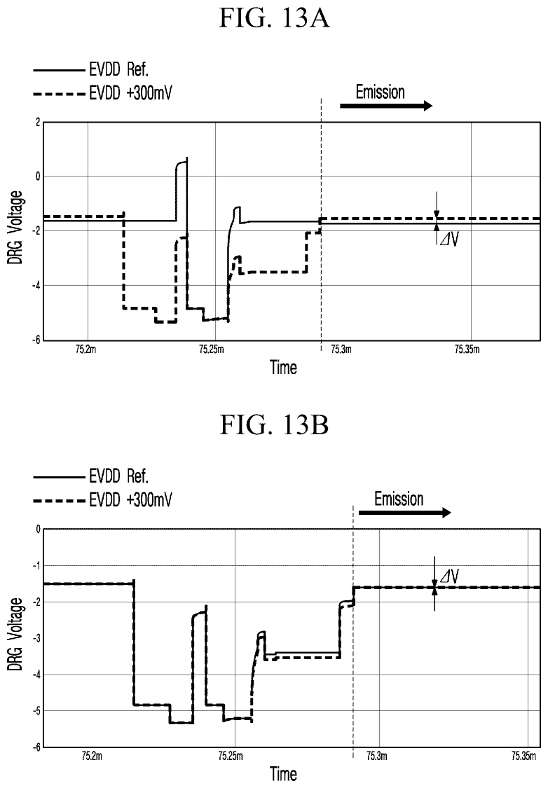

FIGS. 13A and 13B are graphs illustrating simulation results of the gate voltage (DRG Voltage) of the driving TFT DT when EVDD increases by, for example, 300 mV (EVDD+300 mV) compared to a reference voltage (EVDD ref), where FIG. 13A is a simulation result of the subpixel of the comparative example and FIG. 13B is a simulation result of the subpixel of the embodiments of the present disclosure.

When EVDD changes, the voltage of the source node N1 of the driving TFT DT changes.

According to the simulation result of the subpixel of the comparative example of FIG. 13A, when EVDD changes, the gate voltage (DRG Voltage) of the driving TFT DT also changes, and as a result, it is possible to confirm that a difference of β occurs even when light is emitted.

On the other hand, in the subpixel of the embodiments, the voltage of the source node N1 and the voltage of the gate node N2 can be coupled by the second capacitor Cc. Therefore, as in the simulation result of the subpixel of the embodiments of FIG. 13B, even when EVDD changes, the gate voltage (DRG Voltage) of the driving TFT DT can be compensated to minimize the influence of the EVDD change.

The display device according to the embodiments of the present disclosure has the second capacitor Cc connected between the gate node N2 and the source node N1 of the driving TFT DT, initializes the second capacitor Cc when the subpixel is initially driven, and connects the second capacitor Cc between the gate node N2 and the source node N1 when supplying driving power to the driving TFT DT, so that the gate-source voltage Vgs of the driving TFT DT can be stabilized. Accordingly, the change in driving power due to the hysteresis of the driving TFT DT can be minimized, and even when the voltage of the source node N1 changes due to the EVDD change, etc., the voltage of the gate node N2 can be compensated to minimize the influence of the EVDD change.

The embodiments of the present disclosure have at least the following effects and advantages.

The embodiments of the present disclosure can provide a display device capable of improving accuracy and stability of operation of a driving transistor.

The embodiments of the present disclosure can provide a display device capable of reducing a defect (shooting amount ratio (SAR)) in which the luminance of a first frame increases when an image pattern changes from black to white comparing to the case where the image pattern changes from white to white by improving the hysteresis of a driving transistor.

The embodiments of the present disclosure can provide a display device capable of minimizing luminance fluctuation of the display device by minimizing fluctuation in a gate-source voltage Vgs of a driving transistor even when a high-potential voltage EVDD fluctuates due to various causes such as IR drop and voltage coupling.

The effects of the present disclosure are not limited to those illustrated above, and more various effects are included within the present disclosure.

Even though the embodiments of the present disclosure have been described in more detail with reference to the attached drawings, the present disclosure is not necessarily limited to these embodiments, and various modifications can be made without departing from the technical spirit of the present disclosure. Accordingly, the embodiments disclosed in the present disclosure are not intended to limit the technical spirit of the present disclosure but to describe the technical spirit, and the scope of the technical spirit of the present disclosure is not limited by these embodiments. Therefore, it should be understood that the embodiments described above are illustrative and not restrictive in all respects. The scope of protection of the present disclosure should be interpreted by the claims, and all technical ideas within a scope equivalent thereto should be interpreted as being included in the scope of rights of the present disclosure.

What is claimed is:

1. A display device comprising:
a display panel comprising a subpixel configured to display an image; and
a driver configured to drive the display panel,
wherein the subpixel comprises:
a light emitting element;
a driving transistor configured to generate a driving current to be supplied to the light emitting element;
a first capacitor having a first electrode connected to a gate node of the driving transistor and a second electrode connected to a high-potential voltage line; and
a stabilization unit configured to maintain a constant voltage between the gate node and a source node of the driving transistor when the driving transistor generates a driving current according to a voltage of the first capacitor.

2. The display device according to claim 1, wherein:
the driver outputs a scan signal for controlling driving of the subpixel in an initialization period, a data writing period, and an emission period, outputs an on-bias stress (OBS) signal for controlling an OBS period of the subpixel, and outputs a control signal for controlling an operation of the stabilization unit, and
the stabilization unit is initialized in the OBS period of the subpixel according to the control signal of the driver, and maintains a constant voltage between the gate node and the source node of the driving transistor during the emission period of the subpixel.

3. The display device according to claim 2, wherein the stabilization unit comprises:
a second capacitor having a first electrode connected to the gate node of the driving transistor;
a first control transistor configured to be selectively turned on by a first control signal of the driver to connect a second electrode of the second capacitor to an initialization power supply; and
a second control transistor configured to be selectively turned on by a second control signal of the driver to connect the second electrode of the second capacitor to the source node of the driving transistor.

4. The display device according to claim 3, wherein:
the first control transistor is turned on during the OBS period, and
the second control transistor is turned on during the emission period.

5. The display device according to claim 3, wherein the second capacitor is initialized by the initialization power supply during the OBS period, and is connected between the gate node and the source node of the driving transistor during the emission period.

6. The display device according to claim 3, wherein the second capacitor stores a difference voltage between an initialization voltage applied to the gate node of the driving transistor and an OBS voltage applied to the source node of the driving transistor.

7. The display device according to claim 1, wherein the subpixel further comprises:
a first switching transistor having a gate electrode connected to a first scan line, a first electrode connected to a drain node of the driving transistor, and a second electrode connected to the gate node of the driving transistor; and
a second switching transistor having a gate electrode connected to a second scan line, a first electrode connected to a data line, and a second electrode connected to the source node of the driving transistor.

8. The display device according to claim 7, wherein the subpixel further comprises:
a third switching transistor having a gate electrode connected to a light emitting signal line, a first electrode connected to the high-potential voltage line, and a second electrode connected to the source node of the driving transistor; and
a fourth switching transistor having a gate electrode connected to the light emitting signal line, a first electrode connected to the drain node of the driving transistor, and a second electrode connected to an anode of the light emitting element.

9. The display device according to claim 8, wherein the subpixel further comprises:
a fifth switching transistor having a gate electrode connected to a fourth scan signal line, a first electrode connected to a first initialization voltage line, and a second electrode connected to the first capacitor;
a sixth switching transistor having a gate electrode connected to a third scan line, a first electrode connected to an input line of an anode reset voltage, and a second electrode connected to the anode of the light emitting element; and
a seventh switching transistor having a gate electrode connected to the OBS signal line, a first electrode connected to an on-bias stress (OBS) voltage line, and a second electrode connected to the source node of the driving transistor.

10. The display device according to claim 9, wherein the stabilization unit comprises:
a second capacitor having a first electrode connected to the gate node of the driving transistor;
an eighth switching transistor having a gate electrode connected to a fifth scan signal line, a first electrode connected to a second electrode of the second capacitor, and a second electrode connected to an initialization power supply; and
a ninth switching transistor having a gate electrode connected to a sixth scan signal line, a first electrode connected to the second electrode of the second capacitor, and a second electrode connected to the source node of the driving transistor.

11. The display device according to claim 9, wherein the second capacitor is initialized by the initialization power supply and connected between the gate node and the source node of the driving transistor during an emission period.

12. The display device according to claim 1, wherein the stabilization unit comprises a second capacitor having a first electrode connected to the gate node of the driving transistor,
wherein the second capacitor is initialized by an initialization power supply during an on-bias stress (OBS) period of the subpixel, and is connected between the gate node and the source node of the driving transistor during an emission period of the subpixel.

13. The display device according to claim 1, wherein the stabilization unit comprises a second capacitor having a first electrode connected to the gate node of the driving transistor,
wherein the second capacitor stores a difference voltage between an initialization voltage applied to the gate node of the driving transistor and an on-bias stress (OBS) voltage applied to the source node of the driving transistor.

14. The display device according to claim 1, wherein the stabilization unit is initialized in an on-bias stress (OBS) period of the subpixel according to a control signal of the driver, and maintains a constant voltage between the gate node and the source node of the driving transistor during the emission period of the subpixel.

15. A method of driving a display device comprising a light emitting element, a driving transistor configured to generate a driving current to be supplied to the light emitting element, and a first capacitor having a first electrode connected to a gate node of the driving transistor and a second electrode connected to a high-potential voltage line, the method comprising:
applying an initialization voltage to the gate node of the driving transistor, applying an on-bias stress (OBS) voltage to a source node of the driving transistor, and initializing a second capacitor connected to the gate node of the driving transistor by the initialization voltage;
applying the initialization voltage to the gate node of the driving transistor and a drain node of the driving transistor;
storing a data voltage in the first capacitor;
applying an OBS voltage to the source node of the driving transistor; and
configuring the light emitting element to emit light based on a driving current generated from the driving transistor according to the data voltage stored in the first capacitor in a state in which the second capacitor is connected between the gate node and the source node of the driving transistor.

16. The method according to claim 15, wherein the second capacitor stores a difference voltage between the initialization voltage applied to the gate node of the driving transistor and the OBS voltage applied to the source node of the driving transistor.
